(19) United States
(12) Patent Application Publication
(10) Pub. No.: US 2008/0054539 A1
(43) Pub. Date: Mar. 6, 2008

(54) Modular tuning bushing for axle isolation

(76) Inventors: Peter H. Hodges, Livonia, MI (US); Michael Choi, Garden City, MI (US); Phillip J. Kurrle, Macomb Township, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/516,083

(22) Filed: Sep. 6, 2006

(51) Int. Cl. F16F 13/00

(52) U.S. Cl. 267/140.12

(57) ABSTRACT

A bushing includes a hollow shell including an inner surface having central axis, and a sleeve surrounded by the shell. First members are each spaced angularly about the axis, contact the inner surface along the shell, contact and extend along the sleeve, and extend radially between the shell and the sleeve. Second members are each spaced angularly about the axis, releasably secured to the inner surface along the shell, spaced angularly from the first members, extend radially from the inner surface toward the sleeve, and spaced radially from the sleeve.

### BACKGROUND OF THE INVENTION

The preferred embodiment relates generally to a bushing for dynamically interconnecting components of a motor vehicle having relative movement therebetween. In particular, it pertains to a dynamically tuned bushing.

In a rear wheel drive motor vehicle having an independent rear suspension, the rear differential mechanism is supported on a subframe that is fixed on the vehicle's chassis or frame. Due to variable magnitudes of torque transmitted in the driveline and rear differential, there is substantial movement of the differential relative to the subframe, particularly rotation of the differential about the longitudinal axis of the vehicle. In order to accommodate these relative displacements, to provide acceptable vehicle dynamics and to minimize noise vibration and harshness in the vehicle, a bushing having a desired stiffness is secured to the subframe and to the differential at the locations where these components are interconnected.

Preferably these bushings are dynamically tuned, i.e., the stiffness or displacement of certain load paths between the subframe and differential in the bushing due to loads applied to the bushing is established such that a desired response to transients in the drive system are produced. Often the optimal stiffness of the appropriate load paths in the bushing is determined empirically such that vehicle dynamics, noise, vibration and harshness (NVH) and durability criteria are satisfied.

Development of a bushing that meets these criteria requires repeated experimentation with different stiffness rates in the bushing. To accomplish this, a bushing manufacturer must mold and ship to a vehicle manufacturer a number of bushings having mutually different stiffness rates and configurations in order that the vehicle manufacturer can satisfy its packaging, NVH, and durability requirements.

There is a need to provide a modular bushing that significantly reduces time to develop a bushing, which provides optimal dynamic response and stiffness characteristics.

### SUMMARY OF THE INVENTION

A bushing includes a hollow shell including an inner surface having central axis, and a sleeve surrounded by the shell. First members are each spaced angularly about the axis, contact the inner surface along the shell, contact and extend along the sleeve, and extend radially between the shell and the sleeve. Second members are each spaced angularly about the axis, releasably secured to the inner surface along the shell, spaced angularly from the first members, extend radially from the inner surface toward the sleeve, and spaced radially from the sleeve.

The bushing permits its components and the stiffnesses of the bushing assembly to be rapidly adjusted to satisfy NVH requirements and to limit in-service displacement caused by transients, such as motion of the rear drive unit and axle during wide open throttle (WOT) conditions.

The bushing is modular in design. Its shell can be either metal or plastic. Its outer shell and inner sleeve include elements, such as keys, slots, Tees, etc., to which molded, modular elastomeric elements can be affixed, tested, removed, replaced and retested, thereby varying the linear and non-linear portions of a bushing force-deflection curve. These elements allow rapid adjustment of the bushing to satisfy NVH requirements and to limit motion in the driveline.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

These and other advantages will become readily apparent to those skilled in the art from the following detailed description of a preferred embodiment when considered in the light of the accompanying drawings in which:

FIG. 1 is a schematic diagram showing a vehicle driveline to which a tuned bushing can be applied;

FIG. 2 is an end view of a modular, tuned bushing applicable to the driveline of FIG. 1;

FIG. 3 is an end view of an alternate embodiment of the tuned bushing of FIG. 2;

FIG. 4 is an end view of a partially fabricated alternate embodiment of the tuned bushing of FIG. 2;

FIG. 5 is an isometric view of the modular bushing assembly of FIG. 1; and

FIG. 6 is a graph of the force-displacement characteristics of the bushing.

### DESCRIPTION OF THE PREFERRED EMBODIMENT

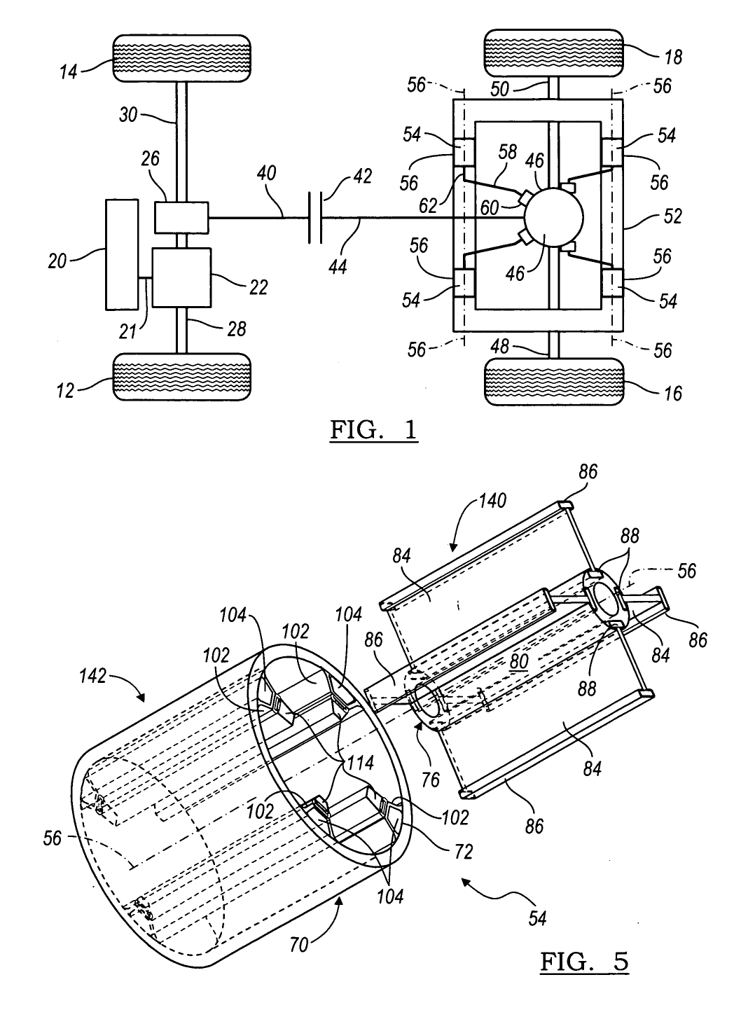

Referring first to FIG. 1, the powertrain for a motor vehicle 10 includes front wheels 12, 14 and rear wheels 16, 18, each wheel fitted with a tire. A power source 20, such as an internal combustion engine or an electric motor, is driveably connected to the input 21 of a transaxle 22, which varies the speed and torque at the transmission output 24 relative to the speed and torque at the transmission input 21. The transmission output 24 is driveably connected to a power takeoff unit (PTU) 26, from which rotating power is transmitted through front axle shafts 28, 30 differentially to the left and right front wheels 12, 14. Either the transaxle 22 or the PTU 26 incorporate a front differential mechanism, which transmits torque to the left and right front wheels 12, 14 and accommodates a speed differential between the front wheels.

The PTU 26 directs rotating power to a front driveshaft 40, which transmits power to a torque biasing device (TBD) 42, whose output is driveably connected by a rear driveshaft 44 to a rear differential mechanism 46. The rear wheels 16, 18 are driveably connected by rear axle shafts 48, 50 to the output of the rear differential mechanism 46. The rear differential 46 may be a conventional mechanism that transmits torque to the left and right rear wheels and accommodates speed differential between the rear wheels.

The TBD 42 includes a coupler for driveably connecting and releasing driveshafts 40 and 44. The coupler may be an electromagnetically-actuated clutch, whose torque capacity varies in response to electric current supplied to an actuating coil, or a hydraulically-actuated multi-disc clutch, whose torque capacity varies in response to the magnitude of pressure supplied to an actuating servo. When the coupler is disengaged, the rear driveshaft 44 is disconnected from the front driveshaft 40, and there is no torque transfer through the coupler 64. A residual drag torque across the coupler may be present; however, this residual torque would not be sufficient to drive the vehicle's wheels.

When the TBD 42 is inactive, i.e., when its coupler is disengaged, the speed of driveshaft 44 is determined by the speed of the rear axles 48, 50 and the drive ratio of the rear differential 46. The magnitude of torque transmitted to driveshaft 44 from driveshaft 40 is determined by the slip across TBD 42.

The rear differential mechanism 46 and related hardware are supported on the subframe 52 of the vehicle at four locations, at each of which an interconnection between the subframe 52 and the supported mass is completed by a bushing 54. The outer surface 56 of each bushing 54 engages the subframe 52 and is preferably that of a circular cylinder having and axis 56 directed laterally along the subframe. The inner surface of each bushing 54 engages a support member 58, which extends outward from a connection 60 to the case of the differential mechanism 46 and includes a hanger portion 62, which extends along axis 56 into the bushing 54.

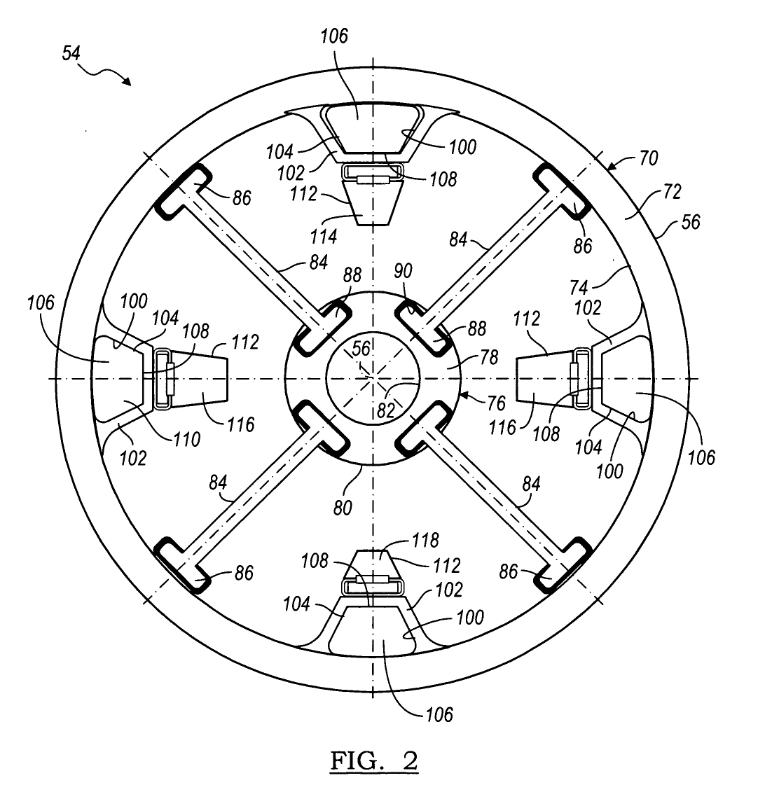

Referring now to FIG. 2, the bushing 54 includes a radial outer shell 70, in the form of a hollow right circular cylinder having a wall 72, an outer surface 56 and an inner surface 74. A hollow sleeve 76, surrounded by shell 54 and concentric with axis 56, is in the form of a hollow right circular cylinder having a wall 78, an outer surface 80 and an inner surface 82.

Spaced angularly about axis 56 and extending radially are four legs 84, each leg having a length that extends along axis 56 between the axial extremities of the bushing 54, a width that extends radially, and a thickness that is directed angularly about axis 56. The radial outer end of each leg 84 is formed with a flange 86, which is secured to the inner surface 74 of the shell 70; the radial inner end of each leg 84 is formed with a flange 88, which is secured to the sleeve 76 by fitting the flange 88 into an axial slot 90 formed in the sleeve.

The bushing 54 can be assembled after removing the sleeve 76 from shell 70. Each leg 84 is readily installed in the sleeve 76 by inserting its inner flange 88 into the corresponding slot 90 at an axial end of the bushing and sliding the leg axially along the slot. Then the sleeve 76 with four legs installed in the slots 90 is inserted into the shell 70 while maintaining each flange 86 in contact with surface 74.

Alternatively, each leg 84 can be readily installed in the bushing 54 by inserting flange 88 into slot 90 at an axial end of the bushing and sliding the leg axially along the slot while maintaining flange 86 in contact with surface 74. Each leg 84 can be readily removed from the bushing 54 by sliding the leg axially along slot 90 until the flange 88 clears an axial end of the bushing.

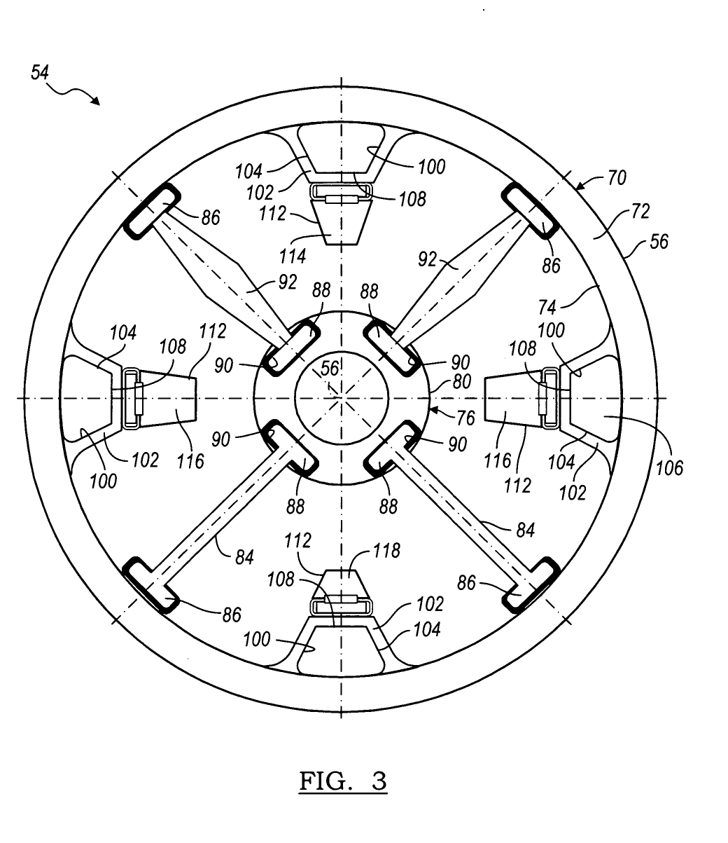

FIG. 3 illustrates a bushing 54 having two legs 84 with a uniform thickness across the width and two legs 92 with a thickness that increases along the width from the radial edges toward the middle of the width. The flanges 86, 88 and the recess 90 of FIG. 3 are as described with reference to FIG. 2.

The wall 72 of the shell 70 illustrated in FIGS. 2 and 3 further includes four axial cavities 100, each cavity being spaced mutually angularly about axis 56 and bounded by the wall 72 and an extension 102 formed integrally with the wall 72. An end view of the bushing 54, such as is illustrated in FIGS. 2 and 3, shows that each cavity 100 defines a trapezoidal space containing an insert 104, whose cross section is substantially trapezoidal. A radial outer surface 106 of each insert 104 contacts surface 74, and a radial inner surface 108 of each insert contacts the radial inner surface 110 of the wall extension 102.

The bushing 54 can be assembled after removing sleeve 76 from shell 70. Each leg 84, 92 is readily installed in the sleeve 76 by inserting its inner flange 88 into the corresponding slot 90 at an axial end of the bushing and sliding the leg axially along the slot. Then each insert 104 can be readily installed in the bushing 54 by inserting an axial end of the insert into a cavity 100 at an axial end of the bushing and sliding the insert axially along the cavity until each axial end of the insert is substantially aligned with an axial end of the bushing. Finally sleeve 76 with four legs installed in the slots 90 is inserted into the shell 70 while maintaining each flange 86 in contact with surface 74.

As FIG. 2 and 3 illustrate, a pad 114 is secured to the radial outer surface 112 of two diametrically opposite extensions 102. The pad 114 is aligned angularly and radially with an insert 104, which extends radially toward axis 56. A similar pad 116 is secured to the radial outer surface 112 of two diametrically opposite extensions 102, is aligned angularly and radially with a corresponding insert 114 and extends a greater radial distance toward axis 56. Another pad 118 is secured to the radial outer surface 112 of the extensions 102 that is diametrically opposite pad 114, is aligned angularly and radially with a corresponding insert 104 and extends a shorter radial distance toward axis 56 than pads 114 and 116. Each of the radial combinations that includes a pad 114, 116, 118, its respective extension 102, and an insert 104 has a different radial compression stiffness from other such combinations due to the difference in the radial length of the pads, even though the material of the pads and inserts of each combination has the same compression modulus. The inboard radial end of each pad 114, 116, 118 is spaced a mutually different distance from surface 80 of the sleeve 76, thereby further affecting the dynamic and structural response of the bushing to radial displacement of the sleeve 76.

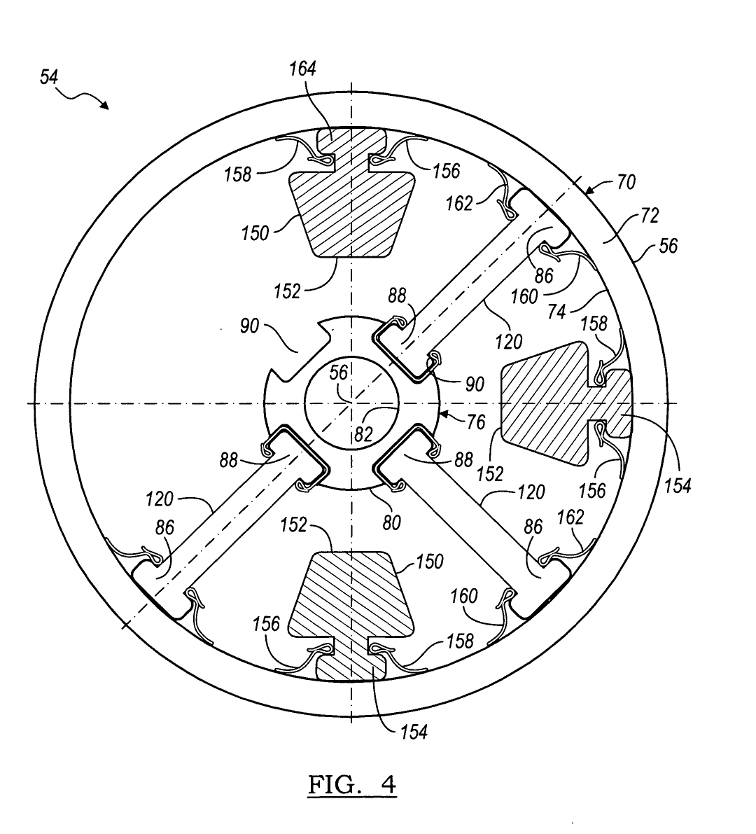

FIG. 4 illustrates a bushing 54 with three radial legs 120 and three snubbers 150 installed in the outer shell 70. Each leg 120 each a greater thickness and a shorter radial width than those of legs 84 and 92; therefore, its compression stiffness in the radial direction is greater than that of legs 84 and 92, provided each leg is made of material having an equal compression modulus. In FIG. 4, the inboard radial end 152 of each snubber 150 is located closer to surface 80 of sleeve 76 than the combinations shown in FIGS. 2 and 3. Therefore, the dynamic and structural response of the bushing 54 to radial displacement of the sleeve 76 first occurs at a lower magnitude of radial displacement of the sleeve than would occur in the bushings shown in FIGS. 2 and 3. An additional snubber 152 and leg 120, each located as shown in FIG. 2, would complete the assembly.

The base 154 of each snubber 150 is secured to the inner surface 74 of outer shell 70 by clips 156, 158, which are secured to surface 74 and engage and secure the snubber to surface 74. Similarly, radial outer flange 86 of each leg 120 is secured to the inner surface 74 of outer shell 70 by clips 160, 162, which are secured to surface 74 and engage and secure the snubber to surface 74. The snubbers 150 and legs 120 can be removed readily in bushing 54 by disengaging them from the retaining clips. The snubbers 150 and legs 120 can be replaced with replacement snubbers and legs by reengaging the clips with the replacements.

In operation, a bushing 54 is assembled as described with reference to FIGS. 2-4, such that when a radial force is applied to the sleeve 76 and is directed along a radial leg 84, 92, 120 the resulting radial displacement of the sleeve has a desired magnitude or is within a desired radial displacement range. The bushing 54 is assembled also such that when a radial force is applied to and directed along a combination that includes a pad, 114, 116, 118, 122, its respective insert 104, 122 and its extension 102 the resulting radial displacement of the sleeve has a desired magnitude or is within a desired radial displacement range. The bushing 54, so constructed, is then installed in the vehicle and tested to determine whether its dynamic performance is acceptable. Components of the bushing 54 can be readily removed and replaced by other components having a different stiffness from that of the removed component such that the radial stiffness of the bushing assembly is changed and produces desired or acceptable performance. The bearing assembly permits its components and the assembly stiffness to be rapidly adjusted to satisfy NVH requirements and to limit in-service displacement caused by transients, such as WOT motion of the rear drive unit and axle.

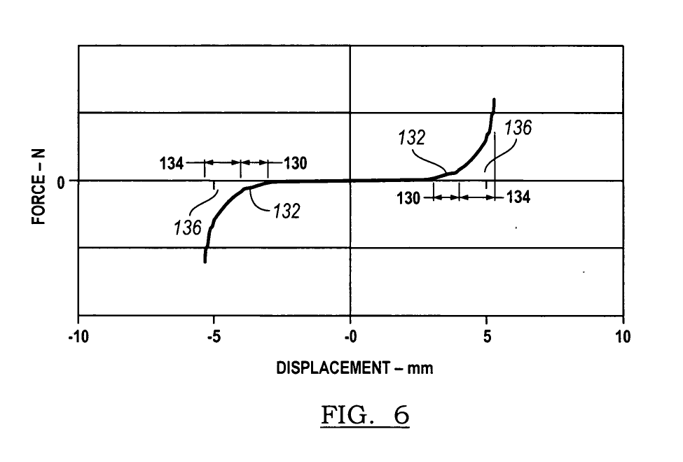

FIG. 6 is a graph showing displacement of the bushing resulting from a radial force applied to the sleeve in opposite directions. Over a first range 130 of the applied force, the bushing assembly's displacement is linear 132 and its slope or modulus is relatively low. Over a second range 134 of the applied force, the bushing assembly's displacement is linear or non-linear 136 and its slope or modulus is relatively high. The first range 130 of displacement is generally established by displacement of the radial legs 84, 92, 120; the second range 134 of displacement is generally established by displacement of the combinations that include a pad, 114, 116, 118, 122, its respective insert 104, 122 and its extension 102.

FIG. 5 shows bushing 54 being assembled by inserting the sleeve module 140 into the shell module 142.

Although the bushing assembly 54 has been described with reference to its radial stiffness with respect to axis 56, the bushing assembly can be constructed to produce a desired axial stiffness along axis 56, a desired torsional stiffness about axis 56, or any combination of radial, axial and torsional stiffnesses.

Preferably the shell 70 and sleeve 76 are of metal or plastic, and the legs, inserts and pads are formed of an elastomer, such as rubber, or are of polymeric materials.

In accordance with the provisions of the patent statutes, the preferred embodiment has been described. However, it should be noted that the alternate embodiments can be practiced otherwise than as specifically illustrated and described.

What is claimed is:

1. A bushing for supporting a component of a motor vehicle driveline on a subframe comprising:
a hollow shell secured to the subframe and including an inner surface having central axis;
a sleeve secured to the driveline component, surrounded by and concentric with the shell;
first members spaced angularly about the axis, contacting the inner surface along the shell, contacting and extending along the sleeve, and extending radially between the shell and the sleeve; and
second members spaced angularly about the axis, releasably secured to the inner surface along the shell, spaced angularly from the first members, extending radially from the inner surface toward the sleeve, and spaced radially from the sleeve.

2. The bushing of claim 1 wherein:
the shell includes supports, each support secured to the shell, spaced angularly about the axis, extending radially toward the axis, and defining a space that extends along the axis and radially from the shell toward the axis; and
a second member further comprises inserts, each insert located in a space, extending along the axis, contacting the inner surface, and extending radially from the inner surface toward the axis.

3. The bushing of claim 1 wherein:
the shell includes supports, each support secured to the shell, spaced angularly about the axis, extending radially toward the axis, and defining a space that extends along the axis and radially from the shell toward the axis; and
a second member further comprises pads, each pad secured to a support, extending along the axis, and extending radially toward the axis.

4. The bushing of claim 1 wherein:
the shell includes supports, each support secured to the shell, spaced angularly about the axis, extending radially toward the axis, and defining a space that extends along the axis and radially from the shell toward the axis; and
a second member further comprises:
inserts, each insert located in a space, extending along the axis, contacting the inner surface, and extending radially from the inner surface toward the axi; and
pads, each pad secured to a support, extending along the axis, and extending radially toward the axis.

5. The bushing of claim 1 wherein a first member further comprises:
a first flange contacting the inner surface and extending along an axial length of the shell;
a second flange contacting and extending along an axial length of the sleeve; and
a web formed integrally with the first flange and the second flange, extending radially between the first flange and the second flange, and extending axially along the first flange and the second flange.

6. The bushing of claim 1 wherein:
the sleeve is formed with a recess facing the inner surface and extending along an axial length of the sleeve; and
a first member further comprises:
a first flange contacting the inner surface and extending along an axial length of the shell;
a second flange engaging the recess, and contacting and extending along an axial length of the sleeve; and
a web formed integrally with the first flange and the second flange, extending radially between first flange and the second flange, extending axially along the first flange and the second flange.

7. A bushing comprising:
a hollow shell including an inner surface having central axis;
a sleeve surrounded by and concentric with the shell;
first members spaced angularly about the axis, contacting the inner surface along the shell, contacting and extending along the sleeve, and extending radially between the shell and the sleeve; and
second members spaced angularly about the axis, releasably secured to the inner surface along the shell, spaced angularly from the first members, extending radially from the inner surface toward the sleeve, and spaced radially from the sleeve.

8. The bushing of claim 7 wherein:
the shell includes supports, each support secured to the shell, spaced angularly about the axis, extending radially toward the axis, and defining a space that extends along the axis and radially from the shell toward the axis; and
a second member further comprises inserts, each insert located in a space, extending along the axis, contacting the inner surface, and extending radially from the inner surface toward the axis.

9. The bushing of claim 7 wherein:
the shell includes supports, each support secured to the shell, spaced angularly about the axis, extending radially toward the axis, and defining a space that extends along the axis and radially from the shell toward the axis; and
a second member further comprises pads, each pad secured to a support, extending along the axis, and extending radially toward the axis.

10. The bushing of claim 7 wherein:
the shell includes supports, each support secured to the shell, spaced angularly about the axis, extending radially toward the axis, and defining a space that extends along the axis and radially from the shell toward the axis; and
a second member further comprises:
inserts, each insert located in a space, extending along the axis, contacting the inner surface, and extending radially from the inner surface toward the axi; and
pads, each pad secured to a support, extending along the axis, and extending radially toward the axis.

11. The bushing of claim 7 wherein a first member further comprises:
a first flange contacting the inner surface and extending along an axial length of the shell;
a second flange contacting and extending along an axial length of the sleeve; and
a web formed integrally with the first flange and the second flange, extending radially between the first flange and the second flange, and extending axially along the first flange and the second flange.

12. The bushing of claim 7 wherein:
the sleeve is formed with a recess facing the inner surface and extending along an axial length of the sleeve; and
a first member further comprises:
a first flange contacting the inner surface and extending along an axial length of the shell;
a second flange engaging the recess, and contacting and extending along an axial length of the sleeve; and
a web formed integrally with the first flange and the second flange, extending radially between first flange and the second flange, extending axially along the first flange and the second flange.

13. A modular bushing comprising:
a first module including:
a hollow shell including an inner surface having central axis, and
first members spaced angularly about the first axis, extending radially from the inner surface toward the first axis, and spaced radially from the sleeve; and
a second module for insertion as a unit into and concentric with the shell, the second module including:
a sleeve having a second axis that is aligned with the first axis upon installing the second module into the shell, and
second first members spaced angularly about the second axis, contacting the sleeve along an axial length, extending radially outward from second axis and the sleeve, spaced angularly from the first members, and contacting the inner surface along an axial length of the shell upon installing the second module into the shell.
